(19) United States
(12) Patent Application Publication
(10) Pub. No.: US 2017/0052891 A1
(43) Pub. Date: Feb. 23, 2017

(54) MULTI-CORE PROCESSOR SYSTEM AND METHOD FOR MANAGING A SHARED CACHE IN THE MULTI-CORE PROCESSOR SYSTEM

(71) Applicant: ELECTRONICS AND TELECOMMUNICATIONS RESEARCH INSTITUTE, Daejeon (KR)

(72) Inventors: Eunji PAK, Daejeon (KR); Hyunwoo JOE, Daejeon (KR); Taeho KIM, Gunpo-si (KR)

(21) Appl. No.: 15/210,270

(22) Filed: Jul. 14, 2016

(30) Foreign Application Priority Data
Aug. 19, 2015 (KR) 10-2015-0116950

(51) Int. Cl. G06F 12/084

(52) U.S. Cl. CPC G06F 12/084; G06F 2212/1008; G06F 2212/281

(57) ABSTRACT

The present invention relates to a multi-core processor system and a method for managing a shared cache in the system. The multi-core processor system in accordance with an embodiment of the present invention includes a plurality of cores, a shared cache, a scheduler configured to assign a plurality of tasks to the cores based on a criticality of the tasks, and a cache manager configured to control use of the shared cache by each of the cores based on the criticality of the tasks assigned to the cores.

### CROSS-REFERENCE TO RELATED APPLICATIONS

This application claims the benefit of Korean Patent Application No. 10-2015-0116950, filed with the Korean Intellectual Property Office on Aug. 19, 2015, the disclosure of which is incorporated herein by reference in its entirety.

### BACKGROUND

1. Technical Field

The present invention relates to a multi-core processor system and a method for managing a shared cache in the multi-core processor system.

2. Background Art

A multi-core processor system refers to a system implemented with two or more computing units called cores. In the multi-core processor system, since multiple cores with lower frequency can work in parallel, we can achieve high performance with less energy.

Typically, in the multi-core processor system, the multiple cores share a cache to improve an efficiency of limited cache resources. However, such cache sharing may deteriorate the system performance if there is a competition for cache resources among the tasks performed by multiple cores at the same time.

Particularly, in a multi-core processor system for mixed-criticality applications (tasks) where the tasks are characterized by different critical levels, it is important to manage the shared cache resources efficiently so as to maintain the efficiency of tasks of low criticality while satisfying the requirements (e.g., time constraints) of tasks of high criticality.

### SUMMARY

Embodiments of the present invention provide a device and a method for satisfying requirements of each task in a multi-core mixed-criticality system in which different tasks having different criticalities are mixed.

A multi-core processor system according to an aspect of the present invention includes: a plurality of cores; a shared cache; a scheduler configured to assign a plurality of tasks to the cores based on a criticality of the tasks; and a cache manager configured to control use of the shared cache by each of the cores based on the criticality of the tasks assigned to the cores.

In an embodiment, each of the tasks is designated, by a user or a developer, as a task of high criticality or a task of low criticality.

In an embodiment, the scheduler may be configured to assign the tasks to the cores in a descending order of criticality.

The scheduler may be configured to assign a task of high criticality to a single core exclusively. Moreover, the scheduler may be configured to assign the task of high criticality first and then assign a task of low criticality to remaining cores.

In an embodiment, the cache manager may be configured to control a core having a task of high criticality assigned thereto to not use the shared cache.

In an embodiment, if a task of high criticality is not expected to satisfy a time constraint, the cache manager may be configured to control a core having the task of high criticality assigned thereto to use a portion of the shared cache exclusively.

In an embodiment, the cache manager may be configured to control a core having a task of low criticality assigned thereto to use the shared cache.

In an embodiment, if a competition for the shared cache is occurred among tasks of low criticality, the cache manager may be configured to prohibit a task causing the competition from using the shared cache.

Another aspect of the present invention features a method for managing a shared cache in a multi-core processor system including a plurality of cores and the shared cache. The method for managing a shared cache in a multi-core processor system in accordance with an embodiment includes: assigning a plurality of tasks to the plurality of cores based on a criticality of each of the tasks; and controlling use of the shared cache by the cores based on the criticality of each of the tasks assigned to the plurality of cores.

According to an embodiment of the present invention, certain features (i.e., multiple core resources and shared cache) of a multi-core processor system are utilized in an environment in which tasks of various criticalities are mixed, thereby improving the performance of the system and increasing the efficiency of the resources while satisfying different requirements of the tasks.

The present invention is contrived considering a multi-core environment, which has been widely propagated recently and is expected to be popularly utilized in the future, and may be utilized in every system in which tasks of various criticalities are mixed. Moreover, the present invention is technically uncomplicated for embodiment, making it very practical for realization.

### BRIEF DESCRIPTION OF DRAWINGS

FIG. 1 is a block diagram illustrating the configuration of a multi-core processor system in accordance with an embodiment of the present invention.

FIG. 2A, FIG. 2B, FIG. 2C and FIG. 2D illustrate examples of assigning tasks having mixed criticality in a multi-core environment in accordance with an embodiment of the present invention.

FIG. 3 is a flow diagram illustrating a method for managing a shared cache in a multi-core processor system in accordance with an embodiment of the present invention.

### DETAILED DESCRIPTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the ideas and scope of the present invention.

Throughout the description of the present invention, when describing a certain relevant conventional technology is determined to evade the point of the present invention, the pertinent detailed description will be omitted.

Unless clearly used otherwise, expressions in a singular form shall be generally interpreted to mean “one or more.”

The embodiments described below are related to measures for managing a shared cache for maintaining an efficiency of tasks having a low criticality while satisfying requirements (e.g., time constraints) of a task having a high criticality in a multi-core processor system based on a mixed criticality in which multiple tasks having various criticalities are mixed.

For instance, in a case where an important task of controlling parts such as wheels or engine that are directly related to safety and a relatively less important task of infotainment are mixed in a single system, the task with a higher criticality is required to be completed within a given time while the task with a relatively lower criticality should be performed efficiently without adversely affecting the task with a higher criticality.

Conventionally, many systems (e.g., embedded system, real-time system, safety-critical system, etc.) mainly carried out a task of a high criticality only. However, with an increased variety of functions and performances owing to the advancement of hardware and software (e.g., from the mere function of driving to the functions of automated parking, autonomous driving, platooning, anti-collision, etc., in the case of automobiles), and with an increased variety of user requirements, tasks of higher criticality and tasks of lower criticality are often mixed in a single system. Accordingly, the embodiments of the present invention described below allow efficient utilization of hardware while satisfying the requirements of each task in a multi-core mixed-criticality system in which multiple tasks having different criticalities are mixed.

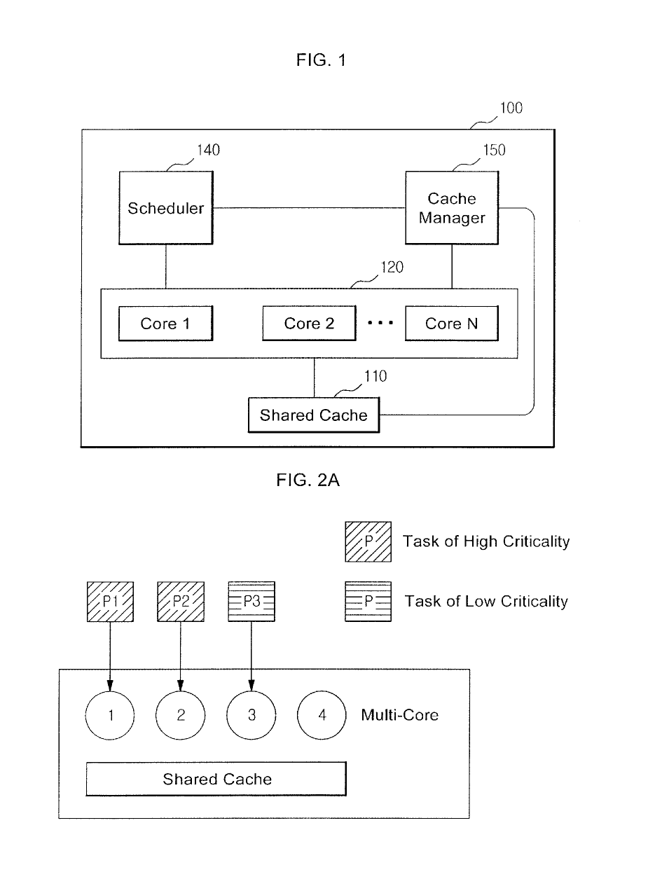

FIG. 1 is a block diagram illustrating the configuration of a multi-core processor system in accordance with an embodiment of the present invention.

As illustrated in FIG. 1, a multi-core processor system 100 in accordance with an embodiment of the present invention may include a shared cache 110, a plurality of cores 120, a scheduler 140 and a cache manager 150.

In an embodiment, each of the tasks is designated, by a user or a developer, as a task of high criticality or a task of low criticality. Generally, the task of high criticality requires time constraints, and if the time constraints are not met, the task of high criticality refers to a task in which a critical accident or loss may be occurred. The task of low criticality refers to a task having no time constraints or having little or no problem occurred even if the time constraints are not met. Based on the criticality of the task defined as described above, the scheduler 140 may perform core assignment, and the cache manager 150 may perform shared cache management.

The scheduler 140 assigns the tasks to the plurality of cores 120, based on the criticality for each task, that is, designated by a user or a developer.

In an embodiment, the scheduler 140 may successively assign the tasks in the plurality of cores 120 in a descending order of criticality. By asigning a single task with a high criticality exclusively in a single core when tasks of various criticalities are executed simultaneously in a multi-core processor, the task is allowed to be executed exclusively by the single core only. Since applications generating a task of high criticality are often developed with a single core in consideration and have requirements to be fulfilled by a single core, such a task does not share the core with other tasks.

After the tasks of a high criticality are preferentially assigned to the cores 120, the scheduler 140 may assign the tasks of a low criticality to the rest of the cores 120.

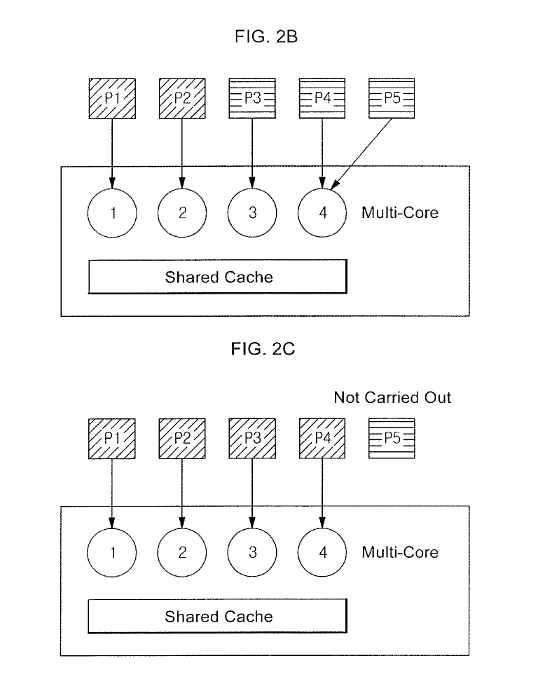

FIG. 2A, FIG. 2B, FIG. 2C and FIG. 2D illustrate examples of assigning tasks having mixed criticality in a multi-core environment in accordance with an embodiment of the present invention.

In FIG. 2A, when P1 and P2 are tasks of high criticality and P3 is a task of low criticality, P1 and P2 may be assigned to Core 1 and Core 2, respectively, and P3 may be assigned to Core 3.

In FIG. 2B, when P1 and P2 are tasks of high criticality and P3, P4 and P5 are tasks of low criticality, P1 to P4 may be assigned to Core 1 to Core 4, respectively, according to their criticality, and P5, of low criticality, may by assigned to Core 4, together with P4, which has a low criticality, as there is no more empty core available. This, of course, is merely an example, and it is also possible that P5 shares Core 3 with P3.

In FIG. 2C, when P1 to P4 are tasks of high criticality and P5 is the only task of low criticality, P1 to P4 may be successively assigned to Core 1 to Core 4, respectively, and then P5, the task of low criticality, may not be assigned to any core because sharing any of Core 1 to Core 4 with P5, the task of low criticality, may cause a problem since P1 to P4 are tasks of high criticality. In such a case, P5 may be finally assigned to one of Cores Ito 4 and executed after execution of any one of P1 to P4 is completed.

In FIG. 2D, when P1 is the only task of high criticality and P2 to P4 are tasks of low criticality, P1 may be exclusively assigned to Core I, and P2 to P4 may be assigned to Core 2 to Core 4.

The cache manager 150 controls whether any of the cores having the tasks assigned thereto shall use the shared cache 110 based on the criticality for each task.

In an embodiment, the cache manager 150 controls the core having the task of high criticality assigned thereto to not use the shared cache 110. This is for meeting the time constraint of the task of high criticality (e.g., a hard real-time task) and for guaranteeing that the task of high criticality is not affected by tasks of low criticality and vice versa. Although not illustrated in FIG. 1, it is possible that use of the shared cache 110 is determined for each core or that the shared cache 110 may be separated and assigned, and the task of high criticality may use a lower-level memory, without using the shared cache 110.

Meanwhile, in the case where a situation is expected that the condition of completing the task of high criticality is not fulfilled within the time constraint (i.e., a deadline miss situation), the cache manager 150 may change the configuration of cache in such a way that the core to which the task is assigned uses a portion of the shared cache 110 exclusively.

The cache manager 150 may control the cores to which tasks of low criticality are assigned to use the shared cache 110. With an increased available capacity of cache, the efficiency of resource utilization and the performance may be improved by sharing cache resources as long as performances are not greatly deteriorated due to competing for the cache resources.

In an embodiment, in the case where the tasks of low criticality are competing for the resource of the shared cache, the cache manager 150 may prohibit the task causing the competition from using the shared cache. Specifically, the cache manager 150 may perform the following operations.

1. The cache manager 150 measures a shared cache miss rate.

2. If the shared cache miss rate of a particular task is greater than a predetermined threshold (e.g., 90%), the cache manager 150 prohibits the particular task from using the shared cache.

3. The cache manager 150 measures the performance of the shared cache for a predetermined period while the particular task is kept from using the shared cache. Then, the cache manager 150 allows the particular task to use the shared cache if the performance of the shared cache is dropped and continues to prohibit the particular task from using the shared cache if the performance of the shared cache is improved.

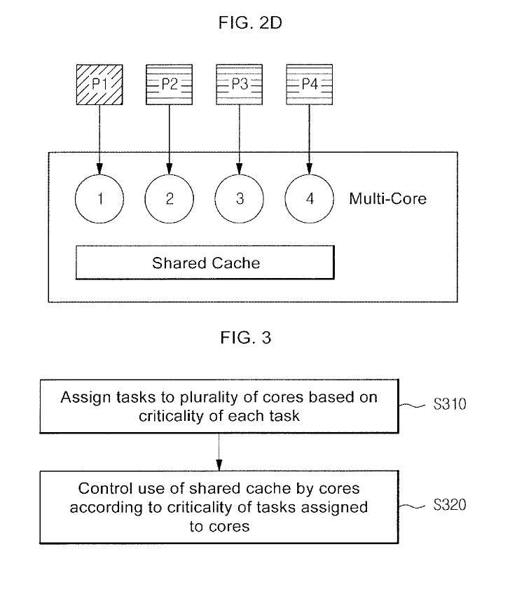

FIG. 3 is a flow diagram illustrating a method for managing a shared cache in a multi-core processor system in accordance with an embodiment of the present invention. Here, it is assumed that the multi-core processor system has a plurality of cores and a shared cache installed therein.

As illustrated, in step S310, tasks are assigned to the plurality of cores based on a criticality of each of a plurality of tasks.

In an embodiment, the criticality of a task may be designated by a user and/or a developer.

In an embodiment, the tasks may be assigned to the plurality of cores in a descending order of criticality. Here, by assigning a single task with high criticality exclusively in a single core, this task is kept from sharing the core with other tasks. This is for meeting the time constraint of the task of high criticality and for guaranteeing that the task of high criticality is not affected by tasks of low criticality and vice versa.

Meanwhile, a task of low criticality may be assigned to a remaining core after the task of high criticality is assigned.

Then, in step S320, use of the shared cache by each of the plurality of cores is controlled according to the criticality of each of the tasks assigned to the plurality of cores.

In an embodiment, it is possible to control the core having the task of high criticality assigned thereto to not use the shared cache.

In another embodiment, if it is expected that the task of high criticality will not satisfy a predetermined time constraint, it is possible to control the core to which the task of high criticality is assigned to use a portion of the shared cache exclusively.

Meanwhile, it is possible to control the cores to which tasks of low criticality are assigned to use the shared cache. With an increased available capacity of cache, the efficiency of resource utilization and the performance may be improved by sharing cache resources as long as performances are not greatly deteriorated due to competing for the cache resources.

In an embodiment, if the tasks of low criticality are competing for the resource of the shared cache, the task causing the competition may be prohibited from using the shared cache. This can be done by measuring a shared cache miss rate of each of the tasks while the tasks are carried out, determining the task of which the shared cache miss rate exceeds a predetermined threshold as a main cause of the competition for the resource of the shared cache, and controlling the task to stop using the shared cache.

The performance of the shared cache is measured for a predetermined period while the particular task is kept from using the shared cache, and then it is possible to control the particular task to use the shared cache again if the performance of the shared cache is dropped.

The apparatus and the method in accordance with an embodiment of the present invention may be implemented in the form of program instructions that are executable through various computer means and written in a computer-readable medium, which may include program instructions, data files, data structures, or the like, in a stand-alone form or in a combination thereof.

The program instructions stored in the computer readable medium can be designed and configured specifically for the present invention or can be publically known and available to those who are skilled in the field of software. Examples of the computer readable medium can include magnetic media, such as a hard disk, a floppy disk and a magnetic tape, optical media, such as CD-ROM and DVD, magneto-optical media, such as a floptical disk, and hardware devices, such as ROM, RAM and flash memory, which are specifically configured to store and run program instructions.

Moreover, the above-described media can be transmission media, such as optical or metal lines and a waveguide, which include a carrier wave that transmits a signal designating program instructions, data structures, etc. Examples of the program instructions can include machine codes made by, for example, a compiler, as well as high-language codes that can be executed by an electronic data processing device, for example, a computer, by using an interpreter.

The above hardware devices can be configured to operate as one or more software modules in order to perform the operation of the present invention, and the opposite is also possible.

Hitherto, certain embodiments of the present invention have been described, and it shall be appreciated that a large number of permutations and modifications of the present invention are possible without departing from the intrinsic features of the present invention by those who are ordinarily skilled in the art to which the present invention pertains. Accordingly, the disclosed embodiments of the present invention shall be appreciated in illustrative perspectives, rather than in restrictive perspectives, and the scope of the technical ideas of the present invention shall not be restricted by the disclosed embodiments. The scope of protection of the present invention shall be interpreted through the claims appended below, and any and all equivalent technical ideas shall be interpreted to be included in the claims of the present invention.

What is claimed is:

1. A multi-core processor system, comprising:
a plurality of cores;
a shared cache;
a scheduler configured to assign a plurality of tasks to the cores based on a criticality of the tasks; and
a cache manager configured to control use of the shared cache by each of the cores based on the criticality of the tasks assigned to the cores.

2. The multi-core processor system of claim 1, wherein each of the tasks is designated, by a user or a developer, as a task of high criticality or a task of low criticality.

3. The multi-core processor system of claim 1, wherein the scheduler is configured to assign the tasks to the cores in a descending order of criticality.

4. The multi-core processor system of claim 1, wherein the scheduler is configured to assign a task of high criticality to a single core exclusively.

5. The multi-core processor system of claim 1, wherein the scheduler is configured to assign a task of high criticality first and then assign a task of low criticality to remaining cores.

6. The multi-core processor system of claim 1, wherein the cache manager is configured to control a core having a task of high criticality assigned thereto to not use the shared cache.

7. The multi-core processor system of claim 1 wherein, if a task of high criticality is not expected to satisfy a time constraint, the cache manager is configured to control a core having the task of high criticality assigned thereto to use a portion of the shared cache exclusively.

8. The multi-core processor system of claim 1, wherein the cache manager is configured to control a core having a task of low criticality assigned thereto to use the shared cache.

9. The multi-core processor system of claim 1, wherein, if a competition for the shared cache is occurred among tasks of low criticality, the cache manager is configured to prohibit a task causing the competition from using the shared cache.

10. A method for managing a shared cache in a multi-core processor system including a plurality of cores and the shared cache, the method comprising:
assigning a plurality of tasks to the plurality of cores based on a criticality of each of the tasks; and
controlling use of the shared cache by the cores based on the criticality of each of the tasks assigned to the plurality of cores.

11. The method of claim 10, wherein each of the tasks is designated, by a user or a developer, as a task of high criticality or a task of low criticality.

12. The method of claim 10, wherein the assigning of the plurality of tasks to the plurality of cores comprises assigning the tasks to the cores in a descending order of criticality.

13. The method of claim 10, wherein the assigning of the plurality of tasks to the plurality of cores comprises assigning a task of high criticality to a single core exclusively.

14. The method of claim 10, wherein the assigning of the plurality of tasks to the plurality of cores comprises assigning a task of high criticality first and then assigning a task of low criticality to remaining cores.

15. The method of claim 10, wherein the controlling of the use of the shared cache by the cores comprises controlling a core having a task of high criticality assigned thereto to not use the shared cache.

16. The method of claim 10, wherein the controlling of the use of the shared cache by the cores comprises, if a task of high criticality is not expected to satisfy a time constraint, controlling a core having the task of high criticality assigned thereto to use a portion of the shared cache exclusively.

17. The method of claim 10, wherein the controlling of the use of the shared cache by the cores comprises controlling a core having a task of low criticality assigned thereto to use the shared cache.

18. The method of claim 10, wherein the controlling of the use of the shared cache by the cores comprises, if a competition for the shared cache is occurred among tasks of low criticality, prohibiting a task causing the competition from using the shared cache.
